(19) United States
(12) Patent Application Publication
(10) Pub. No.: US 2022/0212748 A1
(43) Pub. Date: Jul. 7, 2022

(54) BICYCLE COCKPIT LEVER

(71) Applicant: PNW Components LLC, Seattle, WA (US)

(72) Inventors: Aaron Kerson, Seattle, WA (US); Adam Hammerman, Seattle, WA (US)

(21) Appl. No.: 17/568,636

(22) Filed: Jan. 4, 2022

Related U.S. Application Data
(60) Provisional application No. 63/134,055, filed on Jan. 5, 2021.
(60) Provisional application No. 63/218,837, filed on Jul. 6, 2021.

(51) Int. Cl. B62K 23/06

(52) U.S. Cl. CPC B62K 23/06

(57) ABSTRACT

A bicycle cockpit lever system includes a housing having a first portion thereof and a second portion thereof that can be coupled to one another by a bolt. A lever can be mounted on a roller bearing within the housing such that the lever can be pressed to rotate with respect to the housing to actuate an adjustable component of a bicycle, such as a dropper post thereof. A replaceable thumb pad assembly can be securely and removably coupled to a distal end portion of the lever.

### BACKGROUND

### Technical Field

The present disclosure relates generally to an actuator for use with a bicycle, and more particularly to a bicycle cockpit lever designed to be actuated by a rider's thumb.

### Description of the Related Art

Modern bicycles have a variety of adjustable components, some of which may be adjusted “on-the-fly,” as the bicycle is ridden. Adjustable bicycle components may include front and/or rear brake systems, front and/or rear suspension systems, front and/or rear derailleur systems, and/or a dropper post. A variety of different mechanisms are available to allow adjustment of such components.

As used herein, the term “brake” takes its ordinary meaning in the context of bicycle components. A “front brake” is a component configured to resist rotation of a front wheel of a bicycle with respect to a frame of the bicycle about an axis of rotation of the front wheel, which may be defined by a central longitudinal axis of the front wheel, such as of a hub and/or axle thereof. A “rear brake” is a component configured to resist rotation of a rear wheel of a bicycle with respect to the frame of the bicycle about an axis of rotation of the rear wheel, which may be defined by a central longitudinal axis of the rear wheel, such as of a hub and/or axle thereof. Front and/or rear bicycle brake systems may include rim brakes, disc brakes, or drum brakes.

As used herein, the term “suspension system” takes its ordinary meaning in the context of bicycle components, and includes components configured to insulate a rider from vibrations and other rapid movements caused by rough terrain. Front suspension systems may be built into a head tube or fork of the bicycle, and are designed to insulate the rider from vibrations or other rapid movements of the front wheel. Rear suspension systems are available in a variety of different configurations and are designed to insulate the rider from vibrations or other rapid movements of the rear wheel. Front and/or rear suspension systems may each include one or more springs (e.g., coil springs) or pneumatic or other damping systems (e.g., air springs).

As used herein, the term “derailleur” takes its ordinary meaning in the context of bicycle components. Derailleurs allow a rider to adjust a transmission ratio between the pedals and the driven, rear wheel of the bicycle. Derailleur systems may include a chain, a plurality of front gears or sprockets of different sizes, each configured to engage with the chain, a plurality of rear gears or sprockets of different sizes, each configured to engage with the chain, a front derailleur configured to move the chain between the front sprockets to adjust the transmission ratio, and a rear derailleur configured to move the chain between the rear sprockets to adjust the transmission ratio and to take up slack in the chain resulting from its movement between the sprockets. Front sprockets are coupled, such as directly and/or rigidly, to the pedals, and rear sprockets are coupled, such as directly and/or rigidly, to the rear wheel, such as to a hub or an axle thereof.

As used herein, the term “dropper post” takes its ordinary meaning in the context of bicycle components. Dropper posts are bicycle seat posts or are built into or coupled to bicycle seat posts such that an overall length of the bicycle seat post and/or a distance between the seat of the bicycle and the rest of the frame of the bicycle can be adjusted on the fly, as the bicycle is ridden.

Any of these adjustable components, and any other adjustable components of bicycles known in the art, may be controlled by a rider of a bicycle, such as from what is known as the “cockpit” of the bicycle. To do so, the rider may interact with one or more input devices, including electronic input devices and/or mechanical input devices, such as buttons, switches, levers, etc., to control operation of such components. Such input devices may be coupled to the adjustable components by a variety of mechanisms, such as electronic systems or mechanical systems, such as those incorporating Bowden cables, hydraulic hoses, rods, etc.

### BRIEF SUMMARY

A bicycle cockpit lever system may be summarized as comprising: a lever, including a distal portion of the lever, the lever having an opening that extends through the distal portion of the lever; a thumb pad positioned at a first side of the distal portion of the lever and at a first side of the opening; a nut coupled to the thumb pad, the nut having a first set of threads, the nut extending through the opening; and a bolt having a second set of threads complementary to the first set of threads, the bolt having a head portion positioned at a second side of the distal portion of the lever opposite to the first side of the distal portion of the lever and at a second side of the opening opposite to the first side of the opening, the second set of threads of the bolt threadedly engaged with the first set of threads of the nut.

The distal portion of the lever may comprise a paddle. The lever may include a recess sunken into the first side of the distal portion of the lever. The lever may include a rim that surrounds the recess, an innermost end wall of the recess, and a side wall of the recess that extends from the rim to the innermost end wall. The innermost end wall of the recess may be planar and the side wall of the recess may be perpendicular to the innermost end wall of the recess. The thumb pad may be seated within the recess. The system may further comprise a thumb pad backer, the thumb pad backer located between the thumb pad and the innermost end wall of the recess. The nut may include a disk, the thumb pad may include a recess, and the disk may be seated within the recess. The bicycle cockpit lever system may be coupled to a bicycle and further comprise a cable, the cable having a first end that is coupled to the lever and a second end opposite to the first end that is coupled to a dropper post of the bicycle.

A method of replacing a first thumb pad of a bicycle cockpit lever system with a second thumb pad may be summarized as comprising: threading a first bolt out of a first nut coupled to the first thumb pad; moving the first thumb pad away from a lever of the bicycle cockpit lever system and the first nut out of an opening in the lever; selecting the second thumb pad from a plurality of different thumb pads; moving the second thumb pad toward the lever and a second nut coupled to the second thumb pad into the opening in the lever; and threading a second bolt into the second nut coupled to the second thumb pad.

The plurality of different thumb pads may include thumb pads of different thicknesses. The plurality of different thumb pads may include thumb pads of different materials. The method may further comprise removing a thumb pad backer from the bicycle cockpit lever system. The method may further comprise positioning a thumb pad backer between the second thumb pad and the lever.

A bicycle cockpit lever system may be summarized as comprising: a lever, including a proximal portion of the lever, the lever having an opening that extends through a center of the proximal portion of the lever; a roller bearing mounted inside the opening at the center of the proximal portion of the lever; and a housing, the housing including: a first plate of the housing; a second plate of the housing that is separable from the first plate of the housing and that is spaced apart from the first plate of the housing such that an internal space of the housing is located between the first plate of the housing and the second plate of the housing; and a bolt that extends through the first plate of the housing and into the second plate of the housing to secure the first plate of the housing to the second plate of the housing such that the proximal portion of the lever is located inside the housing and rotatably mounted to the housing by the roller bearing, wherein the bolt can be removed from the first plate of the housing and the second plate of the housing to allow the second plate of the housing to be disconnected from the first plate of the housing.

The proximal portion of the lever may have an overall toroidal shape. The first plate of the housing may be a bottom plate of the housing and the second plate of the housing may be a top plate of the housing. The system may further comprise an internally-threaded projection that is coupled to the second plate of the housing and that extends from the second plate of the housing toward the first plate of the housing through the internal space of the housing. The roller bearing may be mounted on the internally-threaded projection. The bolt may be threaded into the internally-threaded projection.

A bicycle cockpit lever system may be summarized as comprising: a housing having an upper surface; a lever that extends outward from the housing; and a mounting bracket having a lower surface configured to engage with the upper surface of the housing such that a position of the housing is continuously adjustable with respect to a position of the mounting bracket.

The lower surface of the mounting bracket may be configured to engage with the upper surface of the housing such that a position of the housing is continuously adjustable horizontally with respect to a position of the mounting bracket. The mounting bracket may be configured to mount the housing to a bicycle handlebar. The lower surface of the mounting bracket may be configured to engage with the upper surface of the housing such that a position of the housing is continuously adjustable left-to-right with respect to the handlebar. The mounting bracket may be configured to mount the housing to a brake mounted to a bicycle handlebar. The mounting bracket may be configured to mount the housing to a derailleur shifter mounted to a bicycle handlebar. The upper surface of the housing may include a groove, the lower surface of the mounting bracket may include a projection engaged with the groove; the mounting bracket may include a slot; and the system may further comprise a fastener that extends through the slot and that is threaded into the upper surface of the housing.

### BRIEF DESCRIPTION OF THE SEVERAL VIEWS OF THE DRAWINGS

FIG. 1 illustrates a top, right-side, forward-facing perspective view of a bicycle cockpit lever system.

FIG. 2 illustrates the same top, right-side, forward-facing perspective view of a lever of the bicycle cockpit lever system of FIG. 1.

FIG. 3 illustrates the same top, right-side, forward-facing perspective view of a replaceable thumb pad assembly of the bicycle cockpit lever system of FIG. 1.

FIG. 4 illustrates the same top, right-side, forward-facing perspective view of a thumb pad backer of the replaceable thumb pad assembly of FIG. 3.

FIG. 5 illustrates the same top, right-side, forward-facing perspective view of a nut of the replaceable thumb pad assembly of FIG. 3.

FIG. 6 illustrates the same top, right-side, forward-facing perspective view of a screw of the replaceable thumb pad assembly of FIG. 3.

FIG. 7 illustrates a bottom, left-side, rearward-facing perspective view of the bicycle cockpit lever system of FIG. 1.

FIG. 8 illustrates the same bottom, left-side, rearward-facing perspective view of the lever of FIG. 2.

FIG. 9 illustrates the same bottom, left-side, rearward-facing perspective view of the replaceable thumb pad assembly of FIG. 3.

FIG. 10 illustrates the same bottom, left-side, rearward-facing perspective view of a thumb pad of the replaceable thumb pad assembly of FIGS. 3 and 9.

FIG. 11 illustrates the same bottom, left-side, rearward-facing perspective view of the thumb pad backer of FIG. 4.

FIG. 12 illustrates the same bottom, left-side, rearward-facing perspective view of the nut of FIG. 5.

FIG. 13 illustrates a top, right-side, rearward-facing perspective view of the bicycle cockpit lever system of FIGS. 1 and 7.

FIG. 14 illustrates the same top, right-side, rearward-facing perspective view of the lever of FIGS. 2 and 8.

FIG. 15 illustrates the same top, right-side, rearward-facing perspective view of the replaceable thumb pad assembly of FIGS. 3 and 9.

FIG. 16 illustrates the same top, right-side, rearward-facing perspective view of the thumb pad of FIG. 10.

FIG. 17 illustrates the same top, right-side, rearward-facing perspective view of the thumb pad backer of FIGS. 4 and 11.

FIG. 18 illustrates the same top, right-side, rearward-facing perspective view of the nut of FIGS. 5 and 12.

FIG. 19 illustrates a bottom, left-side, rearward-facing perspective view of a first portion of a housing of the bicycle cockpit lever system of FIG. 1.

FIG. 20 illustrates a top, left-side, forward-facing perspective view of the first portion of the housing of FIG. 19.

FIG. 21 illustrates a bottom, left-side perspective view of a second portion of the housing of the bicycle cockpit lever system of FIG. 1.

FIG. 22 illustrates a top perspective view of a screw of the housing of the bicycle cockpit lever system of FIG. 1.

FIG. 23 illustrates a cross-sectional view of the bicycle cockpit lever system of FIG. 1.

FIG. 24 illustrates a cross-sectional view of the housing of the bicycle cockpit lever system of FIG. 1.

FIG. 25 illustrates a cross-sectional view of the replaceable thumb pad assembly of FIGS. 3, 9, and 15.

FIG. 26 illustrates a bicycle.

FIG. 27 illustrates a top, right-side, forward-facing perspective view of another bicycle cockpit lever system.

FIG. 28 illustrates a top, left-side, forward-facing perspective view of a lever portion of the bicycle cockpit lever system of FIG. 27.

FIG. 29 illustrates the same top, left-side, forward-facing perspective view of a replaceable thumb pad assembly of the bicycle cockpit lever system of FIG. 27.

FIG. 30 illustrates the same top, left-side, forward-facing perspective view of the replaceable thumb pad assembly of FIG. 29 with a thumb pad thereof removed.

FIG. 31 illustrates the same top, left-side, forward-facing perspective view of engaged threaded components of the thumb pad assembly of FIG. 29.

FIG. 32 illustrates the same top, left-side, forward-facing perspective view of a screw of the thumb pad assembly of FIG. 29.

FIG. 33 illustrates a top, left-side, rearward-facing perspective view of the lever portion of the bicycle cockpit lever system of FIG. 27.

FIG. 34 illustrates the same top, left-side, rearward-facing perspective view of the replaceable thumb pad assembly of the bicycle cockpit lever system of FIG. 27.

FIG. 35 illustrates the same top, left-side, rearward-facing perspective view of the replaceable thumb pad assembly with the screw of FIG. 32 removed.

FIG. 36 illustrates the same top, left-side, rearward-facing perspective view of the replaceable thumb pad assembly with a thumb pad backer thereof and the screw of FIG. 32 removed.

FIG. 37 illustrates a top, right-side, forward-facing perspective view of a housing of the bicycle cockpit lever system of FIG. 27.

FIG. 38 illustrates a bottom, right-side, forward-facing perspective view of a bracket of the bicycle cockpit lever system of FIG. 27.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with the technology have not been shown or described in detail to avoid unnecessarily obscuring descriptions of the embodiments.

As used herein, terms of orientation or relative elevation such as “top,” “bottom,” “above,” “below,” etc., are used in their conventional sense, that is, with respect to a direction of a force of gravity, such that gravity pulls objects downward. As used herein, terms of orientation or relative location such as “front,” “rear,” etc., are used in their conventional sense with respect to a bicycle, that is, such that a “front” end of the bicycle is the leading end of the bicycle and the “rear” end of the bicycle is the trailing end of the bicycle when the bicycle is ridden in an ordinary fashion. As used herein, terms of orientation or relative location such as “left,” “right,” etc., are used in their conventional sense with respect to the perspective of a rider seated on the bicycle in an ordinary fashion.

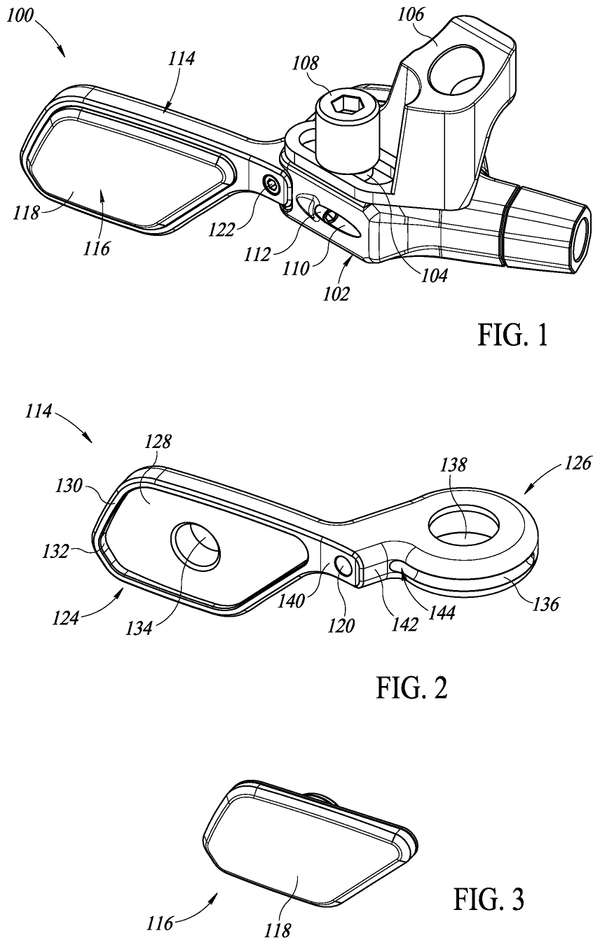

FIG. 1 illustrates a top, right-side, and forward-facing perspective view of a bicycle cockpit lever system 100. As illustrated in FIG. 1, the system 100 includes a hollow housing 102 that houses internal components of the system 100 and to which other components of the system 100, such as a lever 114 thereof, are coupled. The housing 102 includes a projection 104 that extends upward from a top or an upper surface thereof, and which may have a threaded outer surface. As also illustrated in FIG. 1, the system 100 includes a mounting block 106 configured to be securely and rigidly coupled to the frame of a bicycle, and by which the rest of the system 100 may be coupled to the bicycle. As illustrated in FIG. 1, the mounting block 106 includes a slot and the projection 104 of the housing 102 extends through the slot. As also illustrated in FIG. 1, the system 100 includes a nut 108 or other component having a threaded internal surface with threads complementary to those of the projection 104.

When the system 100 is in use, the mounting block 106 can be rigidly coupled to a bicycle. The projection 104 of the housing 102 can be positioned to extend through the slot in the mounting block 106, and the nut 108 can be threaded onto the projection 104 until a portion of the mounting block 106 surrounding the slot is sandwiched and held by friction between the top surface of the housing 102 and a bottom surface of the nut 108, thereby securing the housing 102 to the mounting block 106 and thus to the bicycle.

As illustrated in FIG. 1, the housing 102 includes a first threaded bore hole 110 that extends substantially left-to-right and at a shallow angle with respect to, and into, a rear surface of the housing 102. An internal surface of the first threaded bore hole 110 is threaded. As further illustrated in FIG. 1, the system 100 includes a first threaded set screw 112 having threads complementary to the threads of the first threaded bore hole 110, such that the first threaded set screw 112 can be threaded into and/or out of the first threaded bore hole 110. When the system 100 is in use, the first threaded set screw 112 can be used to adjust a starting or baseline location or orientation of the lever 114 with respect to the housing 102. The first threaded set screw 112 is located and oriented such that it is visible from a forward-facing perspective, that is, from behind or from the perspective of a rider of the bicycle, such that adjustment of the first threaded set screw 112 is simpler and easier than if the first threaded set screw 112 was located elsewhere and/or otherwise oriented.

FIG. 1 further illustrates that the system 100 includes the lever 114, which extends from inside the housing 102 to outside the housing 102, and a removable thumb pad assembly 116 coupled to a distal end portion of the lever 114. The removable thumb pad assembly 116 includes a thumb pad 118 configured to be pressed by a rider using their thumb while riding the bicycle.

FIG. 2 illustrates the lever 114 of the system 100 isolated from the rest of the system 100. As illustrated in FIGS. 1 and 2, the lever 114 has a distal end portion 124 that, when in use, is located outside the housing 102, and a proximal end portion 126 that, when in use, is located inside the housing 102. At a central portion of the lever 114 located between the distal end portion 124 and the proximal end portion 126 thereof, where the distal end portion 124 is joined to the proximal end portion 126, the lever 114 includes a second threaded bore hole 120 that extends substantially front-to-back and substantially directly into a rear surface of the lever 114. An internal surface of the second threaded bore hole 120 is threaded. As further illustrated in FIGS. 1 and 2, the system 100 includes a second threaded set screw 122 having threads complementary to the threads of the second threaded bore hole 120, such that the second threaded set screw 122 can be threaded into and/or out of the second threaded bore hole 120. When the system 100 is in use, the second threaded set screw 122 can be used to secure an end portion of a wire or a cable, such as of a Bowden cable, to the system 100, as described further elsewhere herein. The second threaded set screw 122 is located and oriented such that it is visible from a forward-facing perspective, that is, from behind or from the perspective of a rider of the bicycle, such that adjustment of the second threaded set screw 122 is simpler and easier than if the second threaded set screw 122 was located elsewhere and/or otherwise oriented.

The central portion of the lever 114 has a first, rear surface 140 that extends up-and-down and generally or substantially side-to-side or left-to-right, and which faces rearward, and in which the bore hole 120 is formed. The central portion of the lever 114 also has a second, side surface 142 that extends up-and-down and generally or substantially front-to-back, and generally or substantially parallel to a central longitudinal axis of the bore hole 120, which faces sideways or right-ward, and which adjoins or meets the first surface 140 at a corner of the central portion of the lever 114.

As further illustrated in FIG. 2, the distal end portion 124 of the lever 114 comprises a paddle, or is generally paddle-shaped or has an overall shape generally resembling the profile of a paddle. When the distal end portion 124 of the lever 114 is viewed from a forward-facing perspective, that is, from behind or from the perspective of a rider of the bicycle, its profile initially increases as it extends distally outward and to the left from the central portion of the lever 114, and then eventually decreases as it extends further distally outward and to the left from the central portion of the lever 114. In particular, a top edge of the profile of the distal end portion 124 extends initially substantially horizontally leftward outward away from the central portion of the lever 114 and then both leftward and downward, while a bottom edge of the profile of the distal end portion 124 extends both leftward and downward away from the central portion of the lever 114 and then substantially horizontally leftward further outward away from the central portion of the lever 114 until the top edge of the profile and the bottom edge of the profile meet one another at a lower left-hand corner of the distal end portion 124 of the lever 114. The profile of the distal end portion 124 of the lever 114 thus has an overall shape that is trapezoidal, and in some cases comprises or approximates a parallelogram.

FIG. 2 also illustrates that the distal end portion 124 of the lever 114 has an indentation, a depression, a cavity, or a recess 128 formed in a rear major face or surface thereof. When viewed from a forward-facing perspective, that is, from behind or from the perspective of a rider of the bicycle, the recess 128 fills a substantial majority of the profile of the distal end portion 124 of the lever 114, such that a relatively small rim 130 extends around the periphery of the profile of the distal end portion 124 of the lever 114, such as along the upper and lower edges thereof, and around the recess 128. When viewed from a forward-facing perspective, that is, from behind or from the perspective of a rider of the bicycle, the rim 130 has a constant or substantially constant thickness along its entire length around the periphery of the profile of the distal end portion 124 of the lever 114.

An innermost base or end surface of the recess 128 (which is, in a global sense with respect to the system 100 and/or the bicycle to which the system 100 is coupled as a whole, a front or forward-most surface of the recess 128) is planar, such that planar surfaces of other components of the system 100 can be seated flush against the innermost base or end surface of the recess 128. The innermost base or end surface of the recess 128 also extends horizontally side-to-side or left-to-right, or substantially horizontally side-to-side or left-to-right, and/or vertically up-and-down, or substantially vertically up-and-down.

As further illustrated in FIG. 2, an outer peripheral edge or boundary of the recess 128 and an inner peripheral edge or boundary of the rim 130 are formed or otherwise defined by a wall having a surface 132 that extends around the outer periphery of the recess 128 and around the inner periphery of the rim 130. Thus, the exposed surface 132 of the wall forms a loop around the recess 128, forms sidewalls of the cavity, faces inward toward the recess 128 along its entire length, and defines a depth of the innermost base or end surface of the recess 128 with respect to an outermost end surface of the rim 130. The surface 132 extends along its entire length around the recess 128 in a direction perpendicular to the innermost base or end surface of the recess 128, such that other components of the system 100 having outer side edges perpendicular to the planar surface(s) thereof can be more easily inserted into, seated snugly within, and/or removed from the recess 128. Because the rim 130 has a constant or substantially constant thickness along its entire length around the periphery of the profile of the distal end portion 124 of the lever 114, the surface 132 of the wall has an overall shape matching or substantially corresponding to the overall shape of the profile of the distal end portion 124 of the lever 114 described elsewhere herein.

FIG. 2 also illustrates that the distal end portion 124 of the lever 114 has an aperture or an opening 134 that extends completely through the distal end portion 124 of the lever 114, horizontally front-to-back or substantially horizontally front-to-back from the innermost base or end surface of the recess 128 to a front and/or forward-facing surface of the distal end portion 124 of the lever 114. When viewed from a forward-facing perspective, that is, from behind or from the perspective of a rider of the bicycle, the opening 134 has a circular profile (such that it has an overall cylindrical shape) and fills a relatively small portion of the overall profile of the distal end portion 124 of the lever 114. For example, when viewed from a forward-facing perspective, the circular shape of the opening 134 may have a diameter that is less than a third or less than a quarter of the width of the recess 128, and/or that is less than half or less than a third of the height of the recess 128. The opening 134 has a central longitudinal axis that is perpendicular to the innermost base or end surface of the recess 128 and parallel to the surface 132. Thus, a cylindrical surface of the distal end portion 124 of the lever 114 that faces inward toward the opening 134, and thereby defines an outer periphery of the opening 134, is parallel to the surface 132, such that other components of the system 100 having outer side edges perpendicular to the planar surface(s) thereof to be seated flush against the innermost base surface of the recess 128 can be more easily inserted into, seated snugly within, and/or removed from the opening 134.

As further illustrated in FIG. 2, the proximal end portion 126 of the lever 114 comprises a disk having an aperture or an opening 138 extending through a center of the disk and along a central longitudinal axis of the disk. Thus, the proximal end portion 126 of the lever 114 has an overall shape comprising a torus or a toroid. As illustrated in FIG. 2, the toroidal shape of the proximal end portion 126 of the lever 114 and the opening 138 formed therein share a common central longitudinal axis that is vertical, parallel to the innermost end surface of the recess 128, and/or perpendicular to the central longitudinal axis of the opening 134, or that is substantially vertical, substantially parallel to the innermost end surface of the recess 128, and/or substantially perpendicular to the central longitudinal axis of the opening 134.

FIG. 2 also illustrates that the proximal end portion 126 of the lever 114 includes a groove 136 that extends around a portion of an outer peripheral edge of its toroidal shape, from a location where the proximal end portion 126 of the lever 114 meets and is joined to the central portion of the lever 114, where the groove 136 runs into the side surface 142 thereof, to a location at least 90 or at least 100 degrees about the outer peripheral edge of the toroidal shape from the side surface 142 in a counter-clockwise direction when viewed from above. At the end of the groove 136 at the location where the outer peripheral edge of the toroidal shape meets the side surface 142, the groove 136 terminates at an un-threaded bore hole 144 that extends substantially left-to-right and into the side surface 142 of the central portion of the lever 114. An internal surface of the un-threaded bore hole 144 is not threaded and is instead smooth. A cable, a wire, or another similar component can extend through the bore hole 144 and through the groove 136 so that the cable or wire can smoothly move longitudinally through the bore hole 144 and the groove 136. The threaded bore hole 120 can intersect the bore hole 144 and terminate where it intersects the bore hole 144, such that the set screw 122 can be threaded into the threaded bore hole 120 to secure the cable or wire extending through the bore hole 144 and the groove 136 to the lever 114, such as by friction.

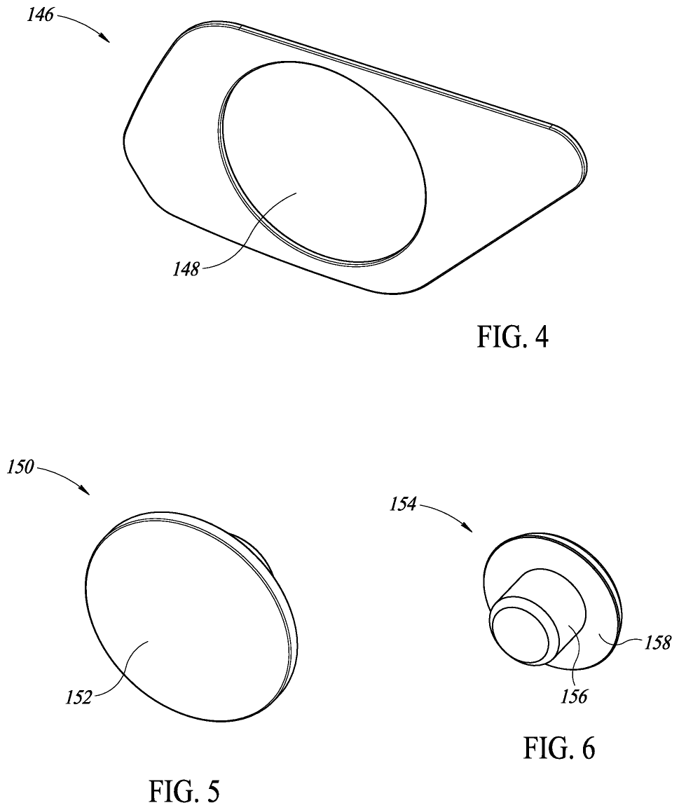

FIG. 3 illustrates the replaceable thumb pad assembly 116, including the thumb pad 118, isolated from the rest of the system 100. As illustrated in FIG. 3, when viewed from a forward-facing perspective, that is, from behind or from the perspective of a rider of the bicycle, portions of the replaceable thumb pad assembly 116, including its thumb pad 118, have an outer profile matching or corresponding to the shape or outer profile of the recess 128, such that the portions of the assembly 116 can be seated snugly within the recess 128. FIG. 4 illustrates a thumb pad backer 146 of the replaceable thumb pad assembly 116 isolated from the rest of the system 100. The thumb pad backer 146 comprises a relatively thin sheet of material, such as a relatively thin sheet of metal, and, as illustrated in FIG. 4, when viewed from a forward-facing perspective, that is, from behind or from the perspective of a rider of the bicycle, has an outer profile matching or corresponding to the shape or outer profile of the recess 128, such that the thumb pad backer 146 can be seated snugly within the recess 128. As further illustrated in FIG. 4, the thumb pad backer 146 has a relatively large aperture or opening 148 that extends front-to-back completely through the thumb pad backer 146. The opening 148 has a diameter that is at least half the width of the thumb pad backer 146 and that is at least half the height of the thumb pad backer 146.

FIG. 5 illustrates a nut 150 of the replaceable thumb pad assembly 116. As illustrated in the forward-facing view of FIG. 5, a rear end of the nut 150 comprises a disk 152 having a diameter matching that of the opening 148 formed in the thumb pad backer 146. Thus, the disk 152 can be seated within the opening 148 when the replaceable thumb pad assembly 116 is fully assembled and/or in use. FIG. 6 illustrates a bolt or screw 154 of the replaceable thumb pad assembly 116. As illustrated in FIG. 6, the screw 154 includes a threaded portion 156 and a head portion 158.

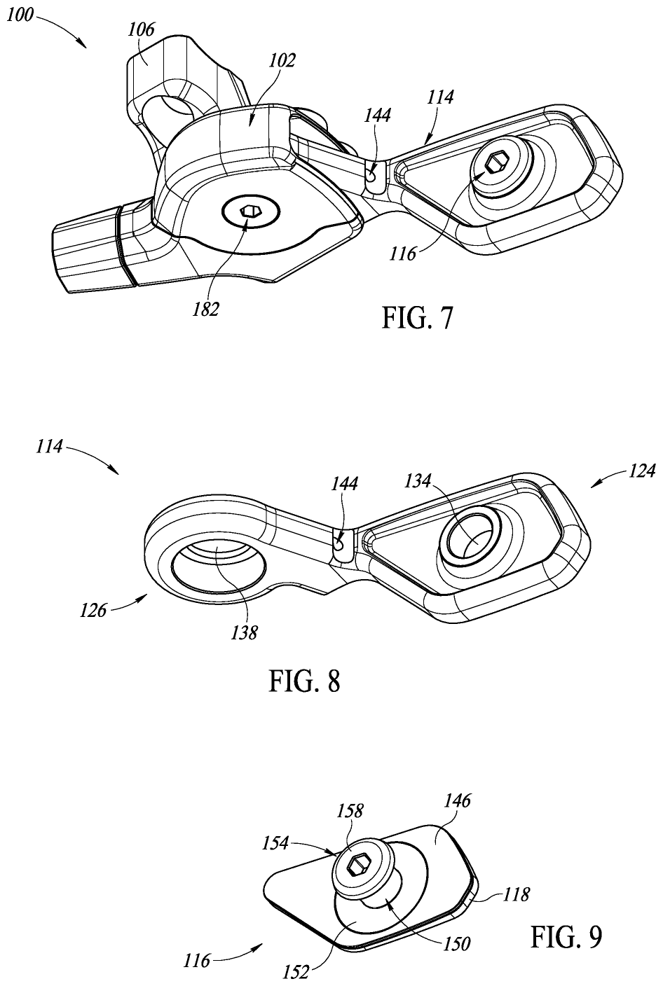

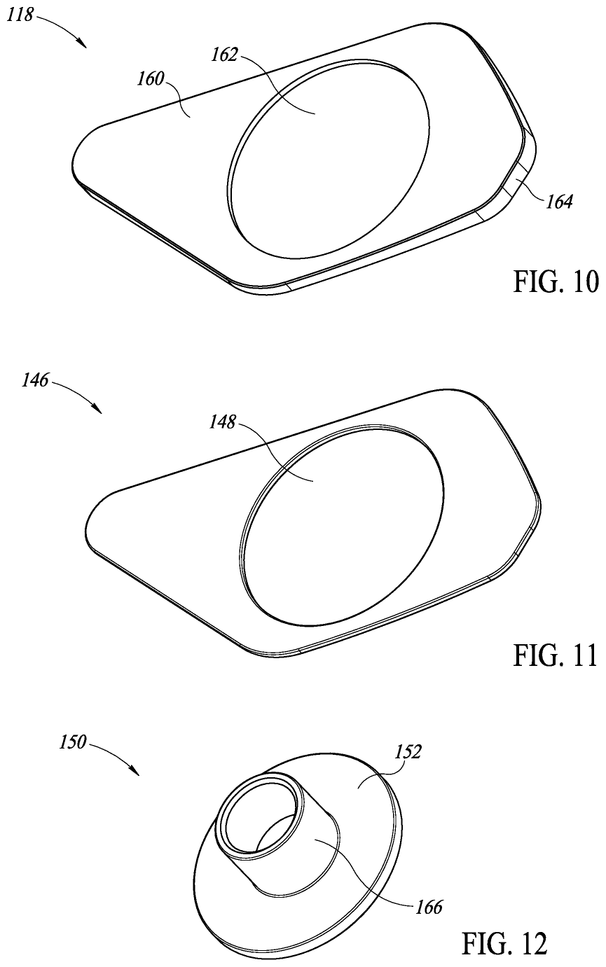

FIGS. 7-12 illustrate bottom, left-side, and rearward-facing perspective views of the bicycle cockpit lever system 100, the lever 114, the replaceable thumb pad assembly 116, the thumb pad 118, the thumb pad backer 146, and the nut 150, respectively. As illustrated in FIG. 10, the thumb pad 118 has a generally planar front surface 160 with a recess 162 formed therein that is sunken and extends rearward with respect to the surrounding front surface 160 of the thumb pad 118. The recess 162 has a generally circular overall profile and a generally cylindrical overall shape that corresponds to or matches the shape of the disk 152 of the nut 150, such that the disk 152 of the nut 150 can be seated snugly within the recess 162 of the thumb pad 118. The recess 162 extends horizontally front-to-back or substantially horizontally front-to-back into and partially through the thumb pad 118. When viewed from a rearward-facing perspective, that is, from in front, the recess 162 fills a relatively large portion of the overall profile of the thumb pad 118. For example, the recess 162 has a diameter that is at least half the width of the thumb pad 118 and that is at least half the height of the thumb pad 118. An innermost base or end surface of the recess 162 may be planar and parallel to the front surface 160 of the thumb pad and a cylindrical surface extending from the innermost base or end surface of the recess 162 to the front surface 160 of the thumb pad 118 may be perpendicular to both the innermost base or end surface of the recess 162 and the front surface 160 of the thumb pad 118. As further illustrated in FIG. 10, a peripheral outer surface 164 of the thumb pad 118, which may be perpendicular to the front surface 160 of the thumb pad 118, extends completely around the outer periphery of the thumb pad 118.

As illustrated in FIG. 12, the nut 150 includes an internally-threaded locking portion 166 coupled to the disk 152. The internally-threaded locking portion 166 comprises a hollow cylindrical body having a central longitudinal axis coincident with a central longitudinal axis of the disk 152. The locking portion 166 has a smooth cylindrical outer surface and a threaded cylindrical internal surface having threads complementary to the threads of the threaded portion 156 of the screw 154, such that the screw 154 can be threaded into or out of the locking portion 166 of the nut 150.

FIG. 9 illustrates the components of the removable thumb pad assembly 116 in an assembled state. As illustrated in FIG. 9, when the removable thumb pad assembly 116 is assembled, the peripheral outer surface 164 of the thumb pad 118 is parallel to, aligned with, and adjacent to a peripheral outer surface of the thumb pad backer 146. Further, a rear surface of the disk 152 of the nut 150 is flush against the innermost base or end surface of the recess 162 formed in the thumb pad 118, the planar front surface 160 of the thumb pad 118 is flush against a planar rear surface of the thumb pad backer 146, and a planar front surface of the thumb pad backer 146 is flush with a front surface of the disk 152 of the nut 150. Thus, when the system 100 is assembled, the flush planar front surfaces of the thumb pad backer 146 and of the disk 152 of the nut 150 lie flush against the innermost base or end surface of the recess 128 formed in the distal end portion 124 of the lever 114, and the locking portion 166 extends through the opening 134 in the distal end portion 124 of the lever 114. In such an arrangement, the disk 152 of the nut 150 prevents the removable thumb pad assembly 116 from moving forward with respect to the lever 114 and the head portion 158 of the screw 154 prevents the removable thumb pad assembly 116 from moving rearward with respect to the lever 114, such that the removable thumb pad assembly 116 is locked in place with respect to the lever 114.

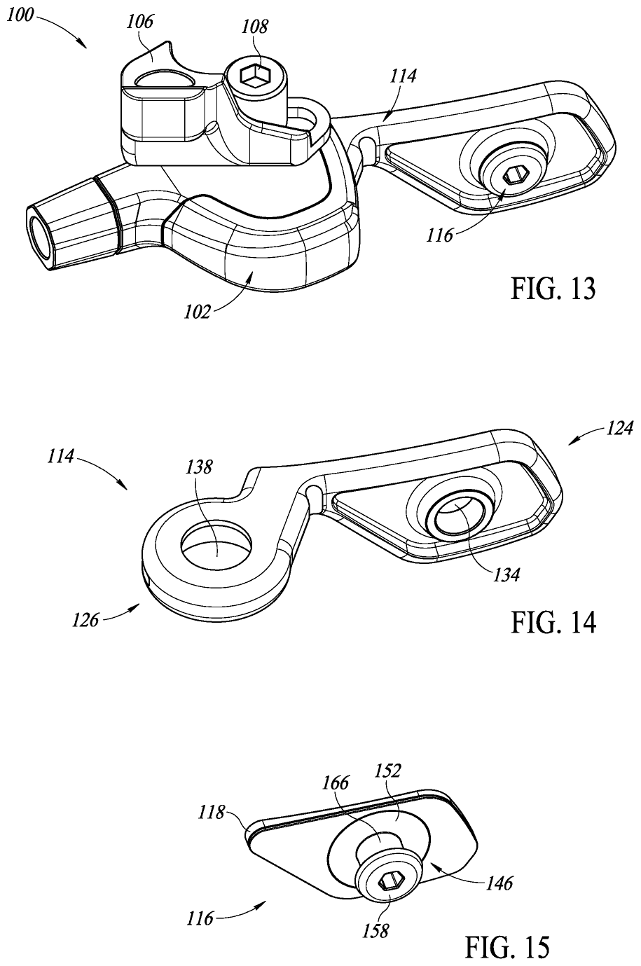

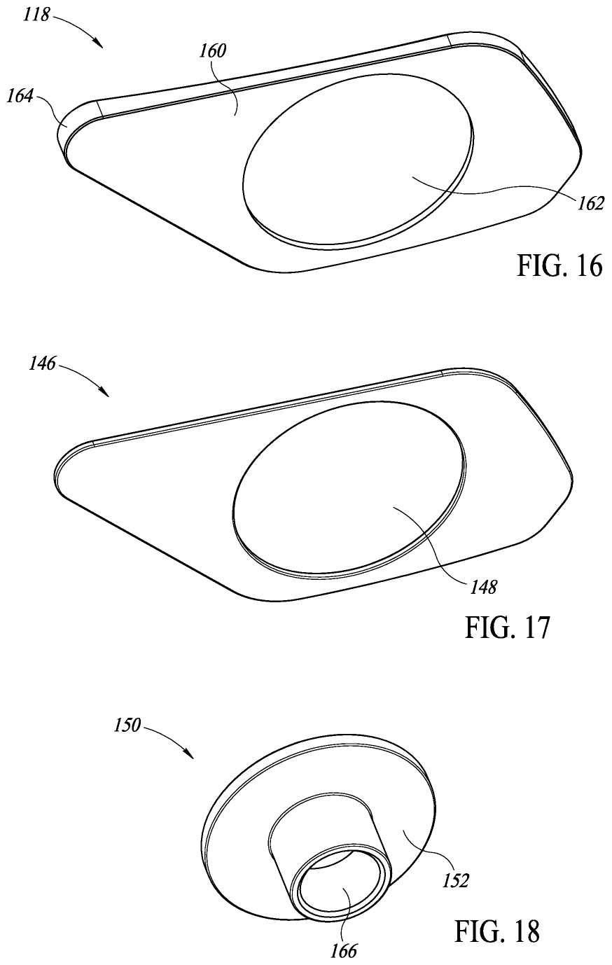

FIGS. 13-18 illustrate top, right-side, and rearward-facing perspective views of the bicycle cockpit lever system 100, the lever 114, the replaceable thumb pad assembly 116, the thumb pad 118, the thumb pad backer 146, and the nut 150, respectively.

A method of assembling the removable thumb pad assembly 116 and coupling the removable thumb pad assembly 116 to the lever 114 includes seating the disk 152 of the nut 150 within the recess 162 of the thumb pad 118 as described elsewhere herein, and securely coupling or fastening the nut 150 to the thumb pad 118 in this configuration, such as with an adhesive, or otherwise providing or obtaining the nut 150 and the thumb pad 118 in such a configuration. The method may further include seating the thumb pad backer 146 on the thumb pad 118 such that the disk 152 of the nut 150 is positioned within the opening 148 in the thumb pad backer 146, and securely coupling or fastening the thumb pad backer 146 to the thumb pad 118 in this configuration, such as with an adhesive, or otherwise providing or obtaining the thumb pad backer 146 and the thumb pad 118 in such a configuration. The method may further include inserting the internally-threaded locking portion 166 of the nut 150 into and through the opening 134 of the lever 114 until the locking portion 166 of the nut 150 is positioned within the opening 134, and the thumb pad backer 146 and the thumb pad 118 are seated within the recess 128 in the distal portion 124 of the lever 114, such that the planar front surface of the thumb pad backer 146 is flush against the planar innermost base or end surface of the recess 128, and such that the peripheral edges of the thumb pad backer 146 and of the thumb pad 118 are engaged with the surface 132 of the wall of the distal portion of the lever 114. The method further includes threading the threaded portion 156 of the screw 154 into the internally-threaded locking portion 166 of the nut 150 until the head portion 158 of the screw 154 engages a front surface of the distal portion 124 of the lever 114, thereby locking the removable thumb pad assembly 116 to the lever 114.

In some alternative implementations, the method includes providing or obtaining the thumb pad backer 146 separated or separately from the thumb pad 118 and the nut 150, such that the thumb pad backer 146 is not securely coupled to the thumb pad 118 or to the nut 150. In such implementations, the method may include seating the thumb pad backer 146 on the thumb pad 118 such that the disk 152 of the nut 150 is positioned within the opening 148 in the thumb pad backer 146, or seating the thumb pad backer 146 in the recess 128 in the distal portion 124 of the lever 114 such that the front surface of the thumb pad backer 146 is flush against the innermost base or end surface of the recess 128. The method may further include inserting the internally-threaded locking portion 166 of the nut 150 into and through the opening 134 of the lever 114 until the locking portion 166 of the nut 150 is positioned within the opening 134, and the thumb pad backer 146 and the thumb pad 118 are seated within the recess 128 in the distal portion 124 of the lever 114, such that the planar front surface of the thumb pad backer 146 is flush against the planar innermost base or end surface of the recess 128, such that the front surface of the thumb pad 118 is flush against the rear surface of the thumb pad backer 146, and such that the peripheral edges of the thumb pad backer 146 and of the thumb pad 118 are engaged with the surface 132 of the wall of the distal portion of the lever 114. The method further includes threading the threaded portion 156 of the screw 154 into the internally-threaded locking portion 166 of the nut 150 until the head portion 158 of the screw 154 engages a front surface of the distal portion 124 of the lever 114, thereby locking the removable thumb pad assembly 116 to the lever 114.

A method of disassembling the removable thumb pad assembly 116 and removing the removable thumb pad assembly 116 from the lever 114 includes threading the threaded portion 156 of the screw 154 out of the internally-threaded locking portion 166 of the nut 150 and then removing the screw 154 from the system 100 such that the removable thumb pad assembly 116 is no longer locked to the lever 114. The method further includes removing the thumb pad 118, the thumb pad backer 146, and the nut 150 from the system 100.

In some implementations, these methods can be used to rapidly replace or exchange different removable thumb pad assemblies 116 from the system 100 and/or from a bicycle. For example, before riding a bicycle, a rider of the bicycle may select one of a plurality of different removable thumb pad assemblies 116, such as one having a thumb pad 118 made of a personally preferred material (e.g., injection molded silicone, rubber, polymer, or metal, which may have a machined surface, etc.), having a preferred thickness, and/or in a preferred color (e.g., teal, orange, grey, black, red, etc.), and then quickly install the removable thumb pad assembly onto the system 100 and the bicycle. As another example, before riding a bicycle, a rider of the bicycle may select one of a plurality of different removable thumb pad assemblies 116, and then quickly remove a less preferred thumb pad assembly from the bicycle and then install the preferred removable thumb pad assembly 116 onto the system. Such methods may also be used to remove the thumb pad assembly 116 for cleaning or other maintenance, or for replacement if damaged and/or worn out.

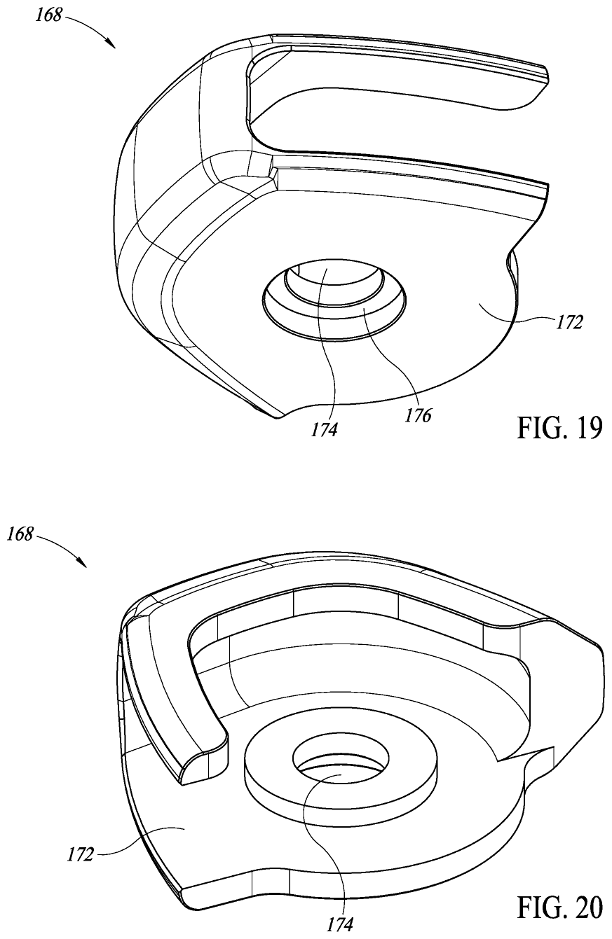

As discussed elsewhere herein, the system 100 includes a hollow housing 102 that houses internal components of the system 100 and to which other components of the system 100, such as the lever 114, are coupled. The housing 102 is formed from two distinct housing portions or components, specifically, a first housing component 168, which may be a front and bottom housing component, and a second housing component 170, which may be a top and rear housing component. FIGS. 19 and 20 illustrate different perspective views of the first housing component 168. In particular, as illustrated in FIGS. 19 and 20, the first housing component 168 includes a bottom plate portion 172 of the housing 102, an aperture or an opening 174 that extends generally vertically through the bottom plate portion 172 of the housing 102, and a groove or a countersink 176 formed in a bottom end surface of the bottom plate portion 172 that surrounds the opening 174 and is configured to receive the head of a screw or bolt extending through the opening 174.

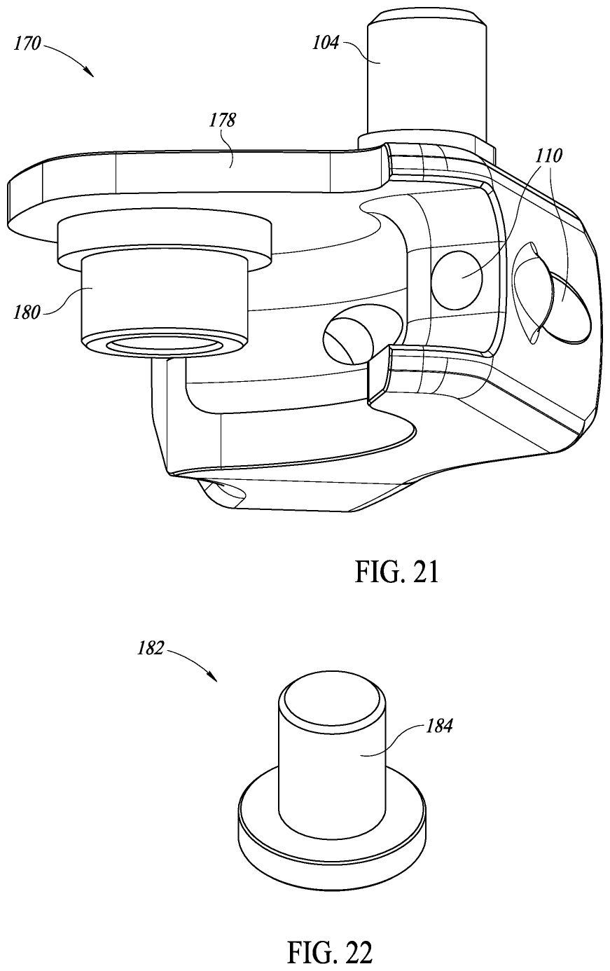

FIG. 21 illustrates a perspective view of the second housing component 170. In particular, as illustrated in FIG. 21, the second housing component 170 includes a top plate portion 178 of the housing 102, the projection 104, which is integrally coupled to or an integral component of the top plate portion 178 of the housing 102, and the first threaded bore hole 110. As illustrated in FIG. 21, the second housing component 170 also includes a projection or an internally-threaded locking portion 180 coupled to an underside or bottom surface of the top plate portion 178 and projecting downward therefrom. The internally-threaded locking portion 180 comprises a hollow cylindrical body having a smooth cylindrical outer surface and a threaded cylindrical inner surface.

FIG. 22 illustrates a perspective view of a bolt or a screw 182 of the housing 102 that can be used to couple the first housing component 168 to the second housing component 170. The screw 182 has a threaded portion 184 having threads complementary to the threads of the internal surface of the internally-threaded locking portion 180 of the second housing component 170, such that the screw 182 can be threaded into or out of the locking portion 180 of the second housing component 170. A method of assembling the housing 102 of the system 100 may include initially coupling various components of the system 100 to the first housing component 168 and/or the second housing component 170, and/or positioning various components of the system 100 within the first housing component 168 and/or the second housing component 170. The method may further include positioning the first housing component 168 and the second housing component 170 adjacent to one another, such that the opening 174 in the first housing component 168 is aligned and concentric with the locking portion 180 of the second housing component 170. The method may further include inserting the screw 182 into and through the opening 174 and then threading the screw 182 into the locking portion 180 of the second housing component 170 until the first housing component 168 is secured to the second housing component 170 and the head portion of the screw 182 is seated within the countersink 176. These actions may be reversed to take apart or disassemble the housing 102 and the system 100.

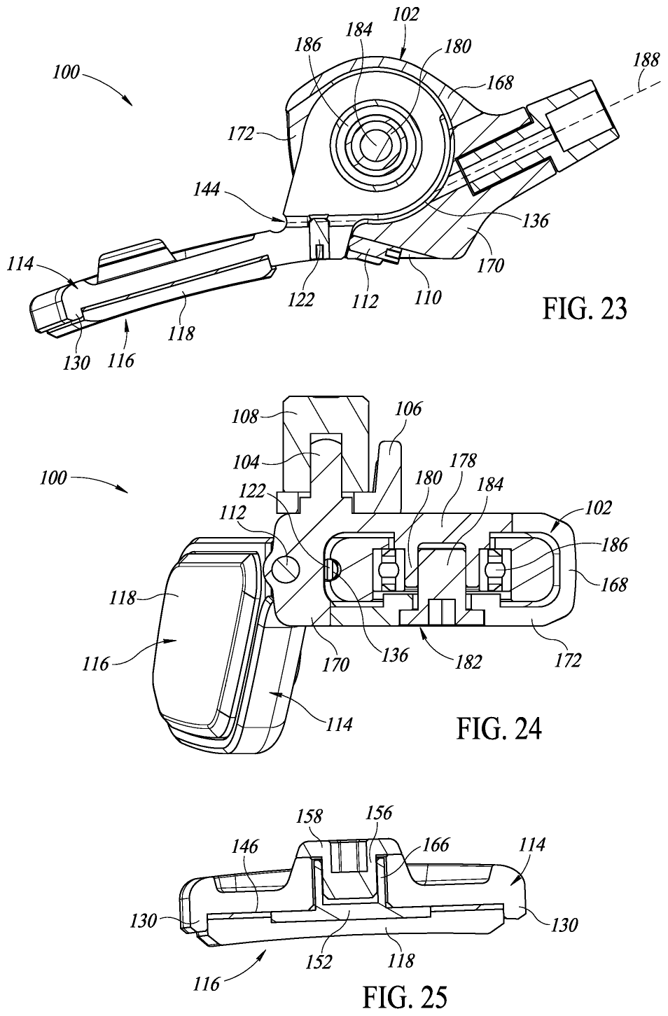

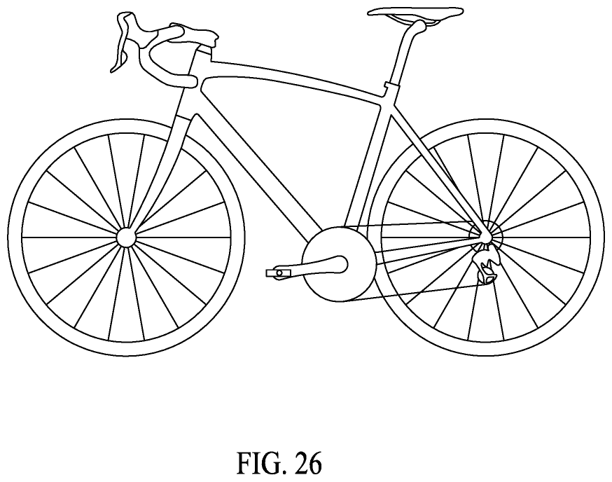

FIG. 23 illustrates a top-down cross-sectional view of the assembled system 100, FIG. 24 illustrates a side-to-side cross-sectional view of the system 100 showing the housing 102 and components housed therein, and FIG. 25 illustrates a side-to-side cross-sectional view of the replaceable thumb pad assembly 116 in an assembled state. As illustrated in FIGS. 23 and 24, the system 100 may include a roller bearing 186 that includes an inner race securely and snugly engaged with the smooth outer surface of the internally-threaded locking portion 180, an outer race securely and snugly engaged with an inner surface of the toroidal shape of the proximal end portion 126 of the lever 114, and a set of ball bearings mounted between the inner and outer races, such that the inner and outer races can rotate with respect to one another with very little friction about a vertical or substantially vertical axis, or about an axis coincident with central longitudinal axes of the threaded portion 184 of the screw 182, the internally-threaded locking portion 180, and the toroidal shape of the proximal end portion 126 of the lever 114 and the opening 138 therein. Thus, the roller bearing 186 allows the lever 114 and the housing 102 to rotate with respect to one another with very little friction about a vertical or substantially vertical axis, or about an axis coincident with central longitudinal axes of the threaded portion 184 of the screw 182, the internally-threaded locking portion 180, and the toroidal shape of the proximal end portion 126 of the lever 114 and the opening 138 therein.

As further illustrated in FIG. 23, the system 100 may include a wire, a cable, or other similar component, such as a Bowden cable 188, which can mechanically couple the lever 114 to another component of the bicycle to be actuated, such as a dropper post thereof. As illustrated in FIG. 23, the cable can extend from the other component of the bicycle, such as from the dropper post, into the housing 102, through the groove 136, and at least partially through the un-threaded bore hole 144. An end of the cable 188, which may be an end of an inner portion of the cable 188 exposed from a sheath portion of the cable 188, can be secured in place within the bore hole 144 by the set screw 122. Specifically, the set screw 122 can be threaded into the bore hole 120 until the end of the cable 188 is held in place by friction between a terminal end portion of the set screw 122 and an opposing surface of the bore hole 144. The set screw 122 can also be threaded out of the bore hole 120 until the end of the cable 188 is no longer held in place by friction between the terminal end portion of the set screw 122 and the opposing surface of the bore hole 144 to allow the cable 188 to be removed from the system 100.

When the system 100 is assembled, coupled to a bicycle, and in operation, a rider of the bicycle can press on the thumb pad 118, such as with their thumb, to rotate the lever 114 clockwise when viewed from above about the central longitudinal axis of the roller bearing 186 with respect to the housing 102. When the rider does so, the lever's attachment to the end of the cable 188 draws or pulls the cable 188 further into the housing 102. Because the opposing end of the cable 188 is mechanically coupled to another component of the bicycle to be actuated, such movement of the cable 188 (e.g., of an internal portion thereof extending through a sheath thereof) can actuate the other component of the bicycle. As examples, the opposing end of the cable 188 can be coupled to front and/or rear brake systems, front and/or rear suspension systems, front and/or rear derailleur systems, and/or a dropper post, to allow the rider to actuate such components by pushing on the thumb pad 118. In one very specific example, pressing on the thumb pad 118 can release a lock preventing adjustment of a dropper post of the bicycle, such that once the rider presses the thumb pad 118, the rider can adjust the dropper post and thereby adjust a height of a seat of the bicycle with respect to a frame of the bicycle, and can do so “on the fly,” as the rider is riding the bicycle.

Any of the components of the system 100 described herein may be fabricated by forging and/or by CNC machining. The system 100 described and illustrated herein is configured to be mounted to a left side of a bicycle, such as to a left side of a set of handlebars of the bicycle, and is configured to be actuated by a rider's left hand. In alternative implementations, however, a system configured to be mounted to a right side of a bicycle, such as to a right side of a set of handlebars of the bicycle, and configured to be actuated by a rider's right hand, may be a mirror image of the system 100. FIG. 26 illustrates one example of a bicycle to which the system 100 may be coupled and with which the system 100 may be used.

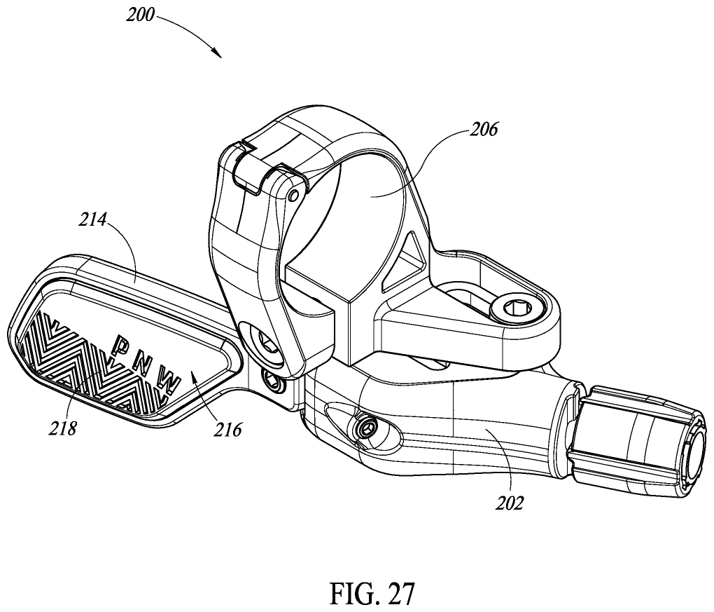

FIGS. 27-38 illustrate various views of another bicycle cockpit lever system 200. For example, FIG. 27 illustrates a top, right-side, and forward-facing perspective view of the bicycle cockpit lever system 200. As illustrated in FIG. 27, the system 200 includes a hollow housing 202 that houses internal components of the system 200 and to which other components of the system 200, such as a lever 214 thereof, are coupled. As also illustrated in FIG. 27, the system 200 includes a mounting clip or bracket 206 configured to be securely and rigidly coupled to the frame of a bicycle, such as to a handlebar of the bicycle, and by which the rest of the system 200 may be coupled to the bicycle. FIG. 27 further illustrates that the system 200 includes the lever 214, which extends from inside the housing 202 to outside the housing 202, and a removable thumb pad assembly 216 coupled to a distal end portion of the lever 214. The removable thumb pad assembly 216 includes a thumb pad 218 configured to be pressed by a rider using their thumb while riding the bicycle. The bicycle cockpit lever system 200 and any or all of its components may have or incorporate any of the features of the bicycle cockpit lever system 100 and any or all of its components described elsewhere herein. Similarly, the bicycle cockpit lever system 100 and any or all of its components may have or incorporate any of the features of the bicycle cockpit lever system 200 as described herein. That is, the features of the bicycle cockpit lever system 100 and of the bicycle cockpit lever system 200 may be combined with each other.

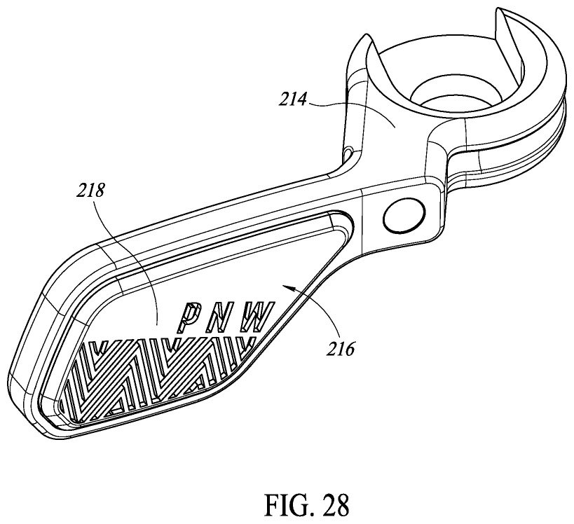

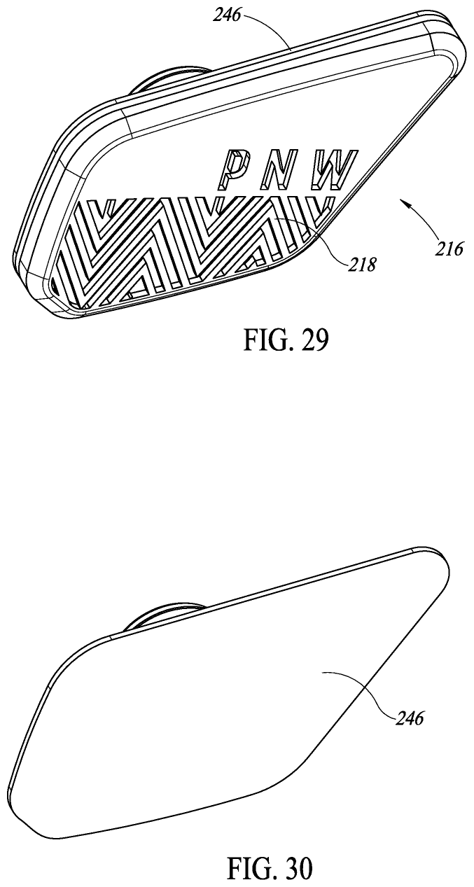

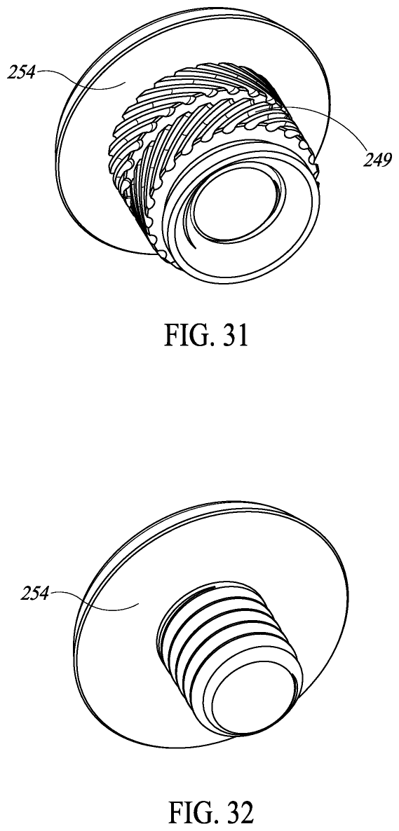

FIG. 28 illustrates the lever 214 of the system 200, and the removable thumb pad assembly 216 coupled thereto, isolated from the rest of the system 200. FIG. 29 illustrates the removable thumb pad assembly 216 isolated from the rest of the system 200, including the lever 214. As illustrated in FIG. 29, the removable thumb pad assembly 216 includes a thumb pad 218 coupled to a thumb pad backer 246 by an adhesive layer, which may be a double-sided tape. FIG. 30 illustrates the removable thumb pad assembly 216 with the thumb pad 218 and the adhesive layer thereof removed. Specifically, FIG. 30 illustrates a rearward-facing surface of the thumb pad backer 246. FIG. 31 illustrates the removable thumb pad assembly 216 with the thumb pad 218, the adhesive layer, and a portion of the thumb pad backer 246 thereof removed. Specifically, FIG. 31 illustrates a threaded insert 249, which is a component of the thumb pad backer 246, and a bolt or screw 254 of the replaceable thumb pad assembly 216. FIG. 32 illustrates the screw 254 of the removable thumb pad assembly 216.

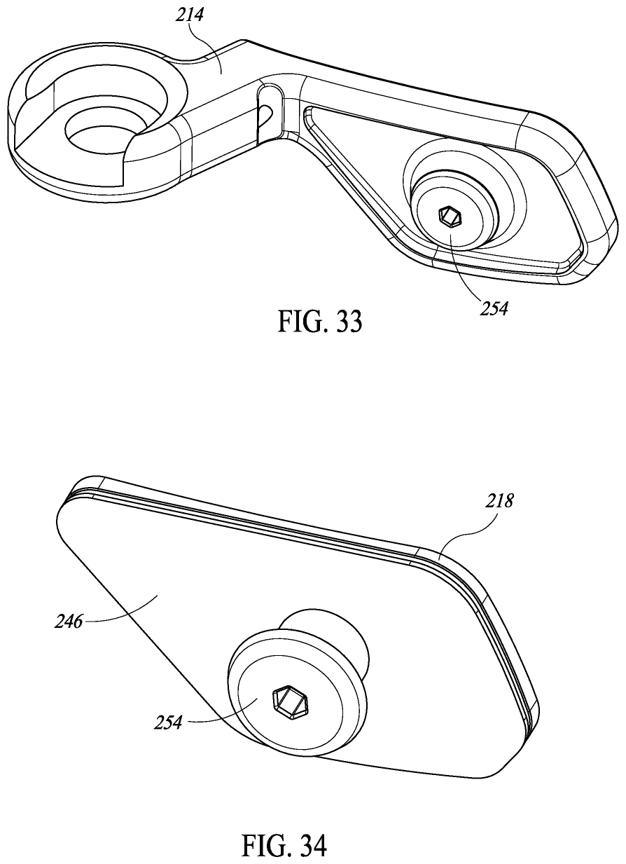

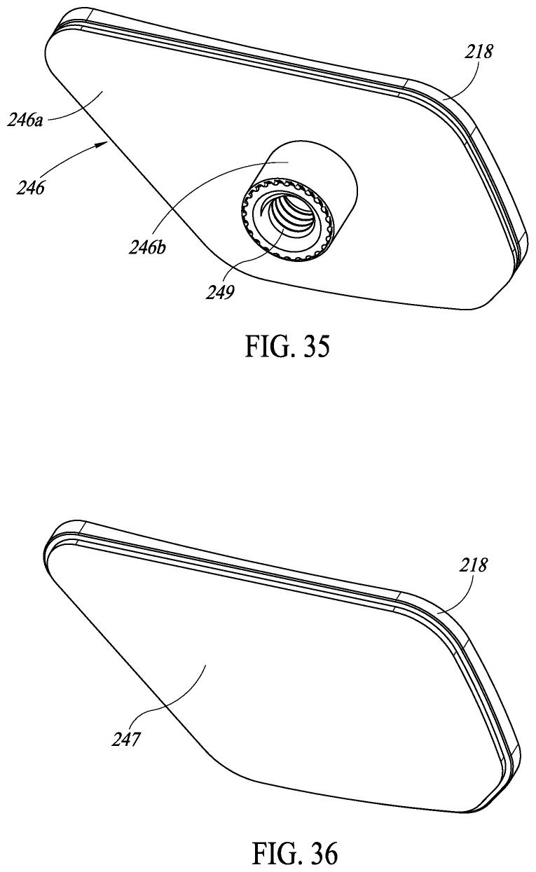

FIG. 33 illustrates the lever 214 of the system 200, and the removable thumb pad assembly 216 coupled thereto, isolated from the rest of the system 200. FIG. 34 illustrates the removable thumb pad assembly 216 isolated from the rest of the system 200, including the lever 214. As illustrated in FIG. 34, the removable thumb pad assembly 216 includes a thumb pad 218 coupled to a thumb pad backer 246 by an adhesive layer. FIG. 35 illustrates the removable thumb pad assembly 216 with the screw 254 thereof removed. Specifically, FIG. 35 illustrates a forward-facing surface of the thumb pad backer 246. FIG. 36 illustrates the removable thumb pad assembly 216 with the screw 254 and the thumb pad backer 246 thereof removed. Specifically, FIG. 36 illustrates the adhesive layer 247 and the thumb pad 218.

A difference between the removable thumb pad assembly 216 of the system 200 and the removable thumb pad assembly 116 of the system 100 is that the removable thumb pad assembly 216 combines the thumb pad backer 146 and the nut 150 into a single component, namely, the thumb pad backer 246. As illustrated in FIG. 35, the thumb pad backer 246 includes a plate portion 246a configured to be positioned and seated within a recess in the lever 214, and a nut portion 246b that protrudes from a forward-facing surface of the plate portion 246a of the thumb pad backer 246. In some embodiments, the nut portion 246b includes an outer, hollow cylindrical or annular portion made of a first material, such as plastic, and an inner, hollow cylindrical or annular portion made of a second material, such as a metal, which may be stronger and/or more rigid than the first material, where the inner portion is located inside of and concentrically with the outer portion.

The inner portion of the nut portion 246b of the thumb pad backer 246 may be referred to as a threaded insert 249. As illustrated in FIG. 31, the threaded insert 249 has a front portion and a rear portion, each having a distinct set of external threads, one of which includes right-handed threads and the other of which includes left-handed threads. These external threads provide rotational engagement with the outer portion of the nut portion 246b of the thumb pad backer 246. For example, the first material (e.g., plastic) of the outer portion of the nut portion 246b of the thumb pad backer 246 may be co-molded with or over the outer or external threads of the threaded insert 249, thereby rotationally locking the outer portion of the nut portion 246b of the thumb pad backer 246 to the threaded insert 249. The threaded insert 249 also has internal threads complementary to outer threads of the screw 254, such that the screw 254 can be threaded into the internal threads of the threaded insert 249. Thus, by providing the threaded insert 249, made of a stronger material than the rest of the thumb pad backer 246, overall engagement of the thumb pad assembly 216 with the lever 214 may be stronger than in embodiments that do not use such a threaded insert.

A method of assembling the removable thumb pad assembly 216 and coupling the removable thumb pad assembly 216 to the lever 214 may include inserting the nut portion 246b of the thumb pad backer 246 into and through an opening in the lever 214 until the threaded insert 249 is positioned within the opening, and the plate portion 246a of the thumb pad backer 246 and the thumb pad 218 are seated within a recess in the distal portion of the lever 214. The method further includes threading a threaded portion of the screw 254 into the internal threads of the threaded insert 249 until a head portion of the screw 254 engages a front surface of the distal portion of the lever 214, thereby locking the removable thumb pad assembly 216 to the lever 214.

A method of disassembling the removable thumb pad assembly 216 and removing the removable thumb pad assembly 216 from the lever 214 includes threading the threaded portion of the screw 254 out of the internal threads of the threaded insert 249 and then removing the screw 254 from the system 200 such that the removable thumb pad assembly 216 is no longer locked to the lever 214. The method further includes removing the thumb pad 218 and the thumb pad backer 246 from the rest of the system 200.

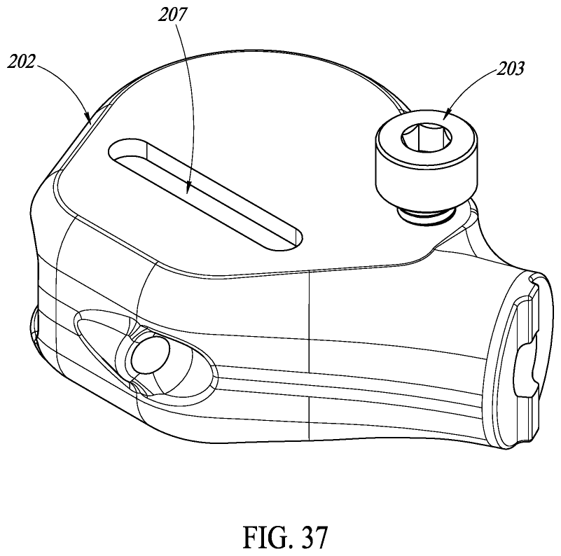

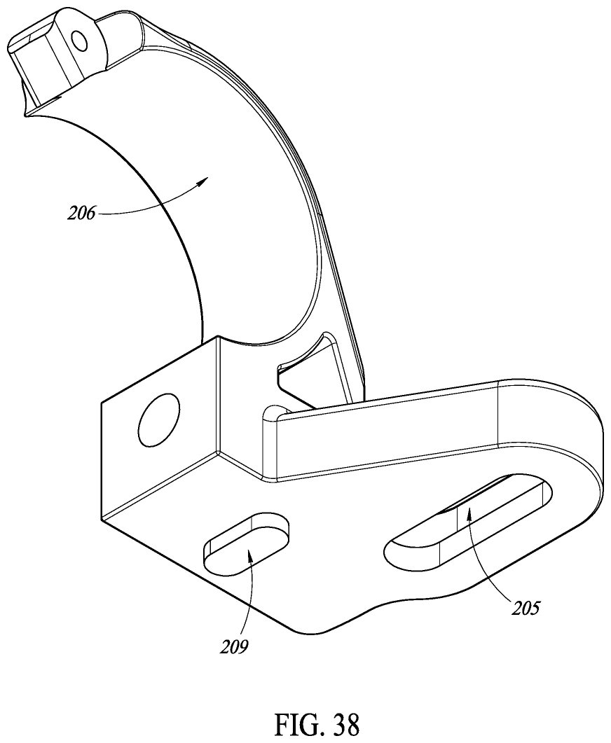

FIG. 37 illustrates a perspective view of the housing 202 of the bicycle cockpit lever system 200. As illustrated in FIG. 37, the housing 202 includes a groove 207 that extends substantially side-to-side or left-to-right across a top or upper surface of the housing 202. As further illustrated in FIG. 37, the housing 202 includes a threaded screw or bolt 203 threaded into the top or upper surface of the housing 202. FIG. 38 illustrates a perspective view of a mounting bracket 206 of the bicycle cockpit lever system 200 that, in use, is coupled to the top or upper surface of the housing 202. As illustrated in FIG. 38, the mounting bracket 206 includes a slot 205 that extends substantially side-to-side or left-to-right across a bottom or lower surface of the mounting bracket 206 and in a direction parallel to the groove 207. As further illustrated in FIG. 38, the mounting bracket 206 includes a ridge or projection 209 that extends downward from the bottom or lower surface of the mounting bracket 206. In some embodiments, the ridge or projection 209 extends substantially side-to-side or left-to-right across the bottom or lower surface of the mounting bracket 206 and in a direction parallel to the groove 207.

To couple the mounting bracket 206 to the housing 202, the bottom surface of the mounting bracket 206 is positioned flush against the top surface of the housing 202 with the ridge or projection 209 positioned within and engaged with the groove 207. The threaded screw or bolt 203 is then positioned to extend from above the mounting bracket 206, through the slot 205 in the mounting bracket 206, and into the top surface of the housing 202. Once in this configuration, the housing 202 and the mounting bracket 206 can move substantially side-to-side or left-to-right with respect to one another. As the components move in this manner, the ridge or projection 209 travels through the groove 207 and the threaded screw or bolt 203 travels through the slot 205. For example, if the mounting bracket 206 has already been rigidly secured to a bicycle handlebar, then the housing 202 can be moved with respect to the mounting bracket 206 to adjust a location of the lever 214 to improve its usability for a particular rider of the particular bicycle to which it is mounted. Thus, a horizontal location of the housing 202 is continuously or infinitely adjustable or variable with respect to the handlebar of the bicycle to which it is mounted, rather than being variable in increments or adjustable in steps.

Once a desirable location has been reached, the threaded screw or bolt 203 can be threaded into the housing 202 until a portion of the mounting bracket 206 surrounding the slot 205 is sandwiched and held by friction between the top surface of the housing 202 and a bottom surface of a head of the threaded screw or bolt 203, thereby securing the housing 202 to the mounting bracket 206 and thus to the bicycle. The dual engagement of the threaded screw or bolt 203 with the slot 205 and the ridge or projection 209 with the groove 207 prevents rotation of the housing 202 with respect to the mounting bracket 206, even if the threaded screw or bolt 203 begins to thread out of the housing 202 or is otherwise slightly loose. The mounting bracket 206 is configured to mount the housing 202 to bicycle handlebars. In additional embodiments other mounting brackets are configured to mount the housing 202 to other bicycle components, such as brakes, derailleur controllers or shifters, etc. In such additional embodiments, the mounting brackets may have the same features described herein for the mounting bracket 206, including the ridge or projection 209 and the slot 205, such that in such additional embodiments, the housing 202 is adjustable with respect to the additional mounting brackets as described herein for the mounting bracket 206.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A bicycle cockpit lever system, comprising:
a lever, including a distal portion of the lever, the lever having an opening that extends through the distal portion of the lever;
a thumb pad positioned at a first side of the distal portion of the lever and at a first side of the opening;
a nut coupled to the thumb pad, the nut having a first set of threads, the nut extending through the opening; and
a bolt having a second set of threads complementary to the first set of threads, the bolt having a head portion positioned at a second side of the distal portion of the lever opposite to the first side of the distal portion of the lever and at a second side of the opening opposite to the first side of the opening, the second set of threads of the bolt threadedly engaged with the first set of threads of the nut.

2. The bicycle cockpit lever system of claim 1 wherein the distal portion of the lever comprises a paddle.

3. The bicycle cockpit lever system of claim 1 wherein the lever includes a recess sunken into the first side of the distal portion of the lever.

4. The bicycle cockpit lever system of claim 3 wherein the lever includes a rim that surrounds the recess, an innermost end wall of the recess, and a side wall of the recess that extends from the rim to the innermost end wall.

5. The bicycle cockpit lever system of claim 4 wherein the innermost end wall of the recess is planar and the side wall of the recess is perpendicular to the innermost end wall of the recess.

6. The bicycle cockpit lever system of claim 4 wherein the thumb pad is seated within the recess.

7. The bicycle cockpit lever system of claim 6, further comprising a thumb pad backer, the thumb pad backer located between the thumb pad and the innermost end wall of the recess.

8. The bicycle cockpit lever system of claim 1 wherein the nut includes a disk, the thumb pad includes a recess, and the disk is seated within the recess.

9. The bicycle cockpit lever system of claim 1 wherein the bicycle cockpit lever system is coupled to a bicycle and further comprises a cable, the cable having a first end that is coupled to the lever and a second end opposite to the first end that is coupled to a dropper post of the bicycle.

10. A method of replacing a first thumb pad of a bicycle cockpit lever system with a second thumb pad, comprising:
threading a first bolt out of a first nut coupled to the first thumb pad;
moving the first thumb pad away from a lever of the bicycle cockpit lever system and the first nut out of an opening in the lever;
selecting the second thumb pad from a plurality of different thumb pads;
moving the second thumb pad toward the lever and a second nut coupled to the second thumb pad into the opening in the lever; and
threading a second bolt into the second nut coupled to the second thumb pad.

11. The method of claim 10 wherein the plurality of different thumb pads includes thumb pads of different thicknesses.

12. The method of claim 10 wherein the plurality of different thumb pads includes thumb pads of different materials.

13. The method of claim 10, further comprising removing a thumb pad backer from the bicycle cockpit lever system.

14. The method of claim 10, further comprising positioning a thumb pad backer between the second thumb pad and the lever.

15. A bicycle cockpit lever system, comprising:
a lever, including a proximal portion of the lever, the lever having an opening that extends through a center of the proximal portion of the lever;
a roller bearing mounted inside the opening at the center of the proximal portion of the lever; and
a housing, the housing including:
a first plate of the housing;
a second plate of the housing that is separable from the first plate of the housing and that is spaced apart from the first plate of the housing such that an internal space of the housing is located between the first plate of the housing and the second plate of the housing; and
a bolt that extends through the first plate of the housing and into the second plate of the housing to secure the first plate of the housing to the second plate of the housing such that the proximal portion of the lever is located inside the housing and rotatably mounted to the housing by the roller bearing, wherein the bolt can be removed from the first plate of the housing and the second plate of the housing to allow the second plate of the housing to be disconnected from the first plate of the housing.

16. The bicycle cockpit lever system of claim 15 wherein the proximal portion of the lever has an overall toroidal shape.

17. The bicycle cockpit lever system of claim 15 wherein the first plate of the housing is a bottom plate of the housing and the second plate of the housing is a top plate of the housing.

18. The bicycle cockpit lever system of claim 15, further comprising an internally-threaded projection that is coupled to the second plate of the housing and that extends from the second plate of the housing toward the first plate of the housing through the internal space of the housing.

19. The bicycle cockpit lever system of claim 18 wherein the roller bearing is mounted on the internally-threaded projection.

20. The bicycle cockpit lever system of claim 18 wherein the bolt is threaded into the internally-threaded projection.

21. A bicycle cockpit lever system, comprising:
a housing having an upper surface;
a lever that extends outward from the housing; and
a mounting bracket having a lower surface configured to engage with the upper surface of the housing such that a position of the housing is continuously adjustable with respect to a position of the mounting bracket.

22. The bicycle cockpit lever system of claim 21 wherein the lower surface of the mounting bracket is configured to engage with the upper surface of the housing such that a position of the housing is continuously adjustable horizontally with respect to a position of the mounting bracket.

23. The bicycle cockpit lever system of claim 21 wherein the mounting bracket is configured to mount the housing to a bicycle handlebar.

24. The bicycle cockpit lever system of claim 23 wherein the lower surface of the mounting bracket is configured to engage with the upper surface of the housing such that a position of the housing is continuously adjustable left-to-right with respect to the handlebar.

25. The bicycle cockpit lever system of claim 21 wherein the mounting bracket is configured to mount the housing to a brake mounted to a bicycle handlebar.

26. The bicycle cockpit lever system of claim 21 wherein the mounting bracket is configured to mount the housing to a derailleur shifter mounted to a bicycle handlebar.

27. The bicycle cockpit lever system of claim 21, wherein:
the upper surface of the housing includes a groove;
the lower surface of the mounting bracket includes a projection engaged with the groove;
the mounting bracket includes a slot; and
the system further comprises a fastener that extends through the slot and that is threaded into the upper surface of the housing.
